(19) United States
(12) Patent Application Publication
(10) Pub. No.: US 2003/0211395 A1
(43) Pub. Date: Nov. 13, 2003

(54) High capacity alkaline batteries with fluorinated graphite containing cathodes

(76) Inventor: Stuart Licht, Haifa (IL)

Correspondence Address: BROWDY AND NEIMARK, P.L.L.C., 624 NINTH STREET, NW, SUITE 300, WASHINGTON, DC, 20001-5303, US

(21) Appl. No.: 10/275,076

(22) PCT Filed: May 1, 2001
(86) PCT No.: PCT/IL01/00390

(51) Int. Cl. H01M 4/58; H01M 4/50; H01M 4/48

(52) U.S. Cl. 429/231.7; 429/224; 429/218.1; 429/221

(57) ABSTRACT

An electric storage alkaline battery comprising an electrically neutral alkaline ionic conductor, an anode and a cathode, whereby electric storage is accomplished via electrochemical reduction of the cathode and oxidation of the anode. The cathode contains a known alkaline cathode material such as either MnO₂, NiOOH, AgO or HgO and an amount of at least 1% of a fluorinated, polymer graphite, and wherein the cathode has a discharge capacity greater than the conventional cathode storage capacity of the known cathode material.

The present invention relates to electric storage batteries. More particularly, the invention relates to a novel electric storage battery with a fluorinated, polymer graphite added to the alkaline cathode.

### BACKGROUND OF THE INVENTION

There is an ongoing need for providing novel improved electric storage batteries, which are low-cost, have a high-energy density. Among the main types of storage batteries are those which contain an, aqueous alkaline electrolyte, typically KOH dissolved in water, examples of these alkaline batteries are NiCad, and metal hydride batteries, as well as several zinc and iron anode batteries, and include, but are not limited to, those in which the cathodes (the positive electrodes) are based on any of AgO, HgO, an Fe(VI) salt or most typically MnO₂ or NiOOH.

Fluorinated, polymer graphite materials refer to a group of materials described by the chemical formula (CₓF)ₙ, and which have also be described by the weight percent of fluorine, y%, contained in the carbon. The various preparations of these fluorinated, polymer graphite, FG, materials has been widely described in the literature, and these materials have recently become commercial available through Aldrich Chemical Company, as separate materials containing a wide range of fluorine varying from y=27% to y=62%. These FG materials have been widely reported in the literature for use in non-aqueous lithium and lithium-ion batteries.

FG materials may be prepared by the chemical reaction of carbon based materials or graphites and fluorine based materials at a variety of temperatures, pressures and reaction conditions. This chemical combination includes, but is not limited to preparations described in T. Nakajima, M. Koh, R. N. Singh, M. Shimada, Electrochim, Acta 44 (1999) 2879; R. Yazami, P. Hany, P. Masset, A. Hamwi, Mol. Cryst. Liq. Cryst. Sci. Technol. 310 (1998) 397; A. Hamwi, I. Al Saleh, J. Power Sources 48 (1994) 311; P. Hany, R. Yazami, A. Hamwi, J. Power Sources 68 (1997) 708; and Watanaba, Nobuatsu, Solid State Ionics 1 (1980) 87. Fluorinated, polymer graphites, ranging from those containing 27% up to those containing 62% fluorine by weight may also be purchased from Aldrich Chemical company.

Little attention has been given to their aqueous properties of FG materials. The few aqueous disclosures of FG materials are U.S. Pat. No. 5,712,062 Yamana et al (1998 to Daikin Ind., Osaka), which describes use of carbon fluoride particles as an air electrode component in zinc air batteries, as a negative plate additive in nickel metal hydride batteries and as“an agent for imparting electrical conductivity” directed at printer/Xerox technology. U.S. Pat. No. 4,431,567 Gestaut (1984 to Diamond Shamrock), discloses use of optionally precious metal catalyzed carbon fluoride for alkaline electrolytes/chloralkali synthesis cells and in U.S. Pat. No. 5,116,592 Weinberg (1990 to Electrosynthesis Co.) use of fluorinated carbons is disclosed for electrical energy consumption and generation cells, focusing on the grounds of improved stability, and as a conductive additive. In none of these cases is the FG added to a cathode material indicated to give more than the theoretical cathode storage capacity.

Recently, FG materials have been proposed as an additive to improve discharge capacity of Fe(VI) cathodes (S. Licht',“A Conductive Iron-Based Storage Battery” US Continuation In Part, submitted Mar. 6, 2000). In that application it was not suggested or claimed that added FG would deliver more that the theoretical capacity of the Fe(VI) cathode or that the improved Fe(VI) capacity could reach beyond the theoretical discharge capacity of the Fe(VI) cathode. In that application, the theoretical discharge capacity of the Fe(VI) cathode was described as the three-electron reduction of these materials as expressed in the equation:

FeO₄²+3H₂O+3e⁻→FeOOH+50H³¹ (1)

It is an object of the present invention to provide an additive to the cathode in alkaline batteries which provides a practical storage capacity greater than the theoretical capacity known for these cathode materials.

### BRIEF DESCRIPTION OF THE INVENTION:

The invention relates to an electrical storage cell, so-called alkaline battery, comprising two half-cells which are in electrochemical contact with one another through an electrically neutral alkaline ionic conductor, wherein one of said half-cells comprises an anode and the other half-cell comprises a cathode, whereby electrical storage is accomplished via electrochemical reduction of the cathode and oxidation of the anode. The cathode contains a known alkaline cathode material such as either MnO₂, NiOOH, AgO or HgO and an amount of at least 1% of a fluorinated, polymer graphite, and wherein the cathode has a discharge capacity greater than the conventional cathode storage capacity of the known cathode material.

### BRIEF DESCRIPTION OF THE FIGURES

FIG. 1 is a diagrammatic illustration of the fluorinated, polymer graphite containing cathode battery according to the invention; and

FIGS. 2 to 6: illustrate graphically performance of various battery aspects according to the invention as described in the Examples.

### DETAILED DESCRIPTION OF THE INVENTION

The novel battery according to the present invention is based on the addition of a fluorinated, polymer graphite,“FG”, material to a known cathode material, where yielding a storage capacity greater than that of the storage capacity of the known cathode material.

The phrase“conventional cathode storage capacity” refers to the theoretical charge capacity of that cathode material in accord with the known number of faradays (moles electrons) stored per mole of that material. The theoretical charge capacity is calculated through equation 2 and where n is the number of discharge electrons, F is the Faraday's constant=26.801 Amp hour per mol, and Fw is the formula weight:

Theoretical charge capacity=n×F/Fw (2)

For any specified known cathode material, discharged at low current density rate, the phrase“conventional cathode storage capacity” is specifically the theoretical charge capacity of that cathode material. At higher rates of current density, this“conventional cathode storage capacity” is less than the theoretical charge capacity, and refers to the maximum amount of cathode storage capacity previously attainable for the cathode material at this discharge condition. Table 1 presents the theoretical storage capacity of various cathode materials calculated in accord with equation 2.

TABLE 1
Theoretical charge capacity of several known cathode materials,
determined with equation 2

| cathode | | | Fw | Charge capacity |
|---|---|---|---|---|
| material | cathode name | n | kg/mole | Amp hour/kg |
| MnO₂ | manganese dioxide | 1 | 86.9 | 308 |
| NiOOH | nickel oxyhydroxide | 1 | 91.7 | 289 |
| Ag₂O | silver oxide | 2 | 231.7 | 231 |
| HgO | mercury oxide | 2 | 216.6 | 247 |
| K₂FeO₄ | potassium Fe(VI) | 3 | 198.1 | 406 |
| BaFeO₄ | barium Fe(VI) | 3 | 257.2 | 313 |

Fluorinated, polymer graphite added to the cathode material cell can yield greater than the conventional cathode capacity of the cathode material. In a preferred embodiment this can include at least 1% added PG. In another preferred embodiment this can include at least 10% added FG. In one preferred embodiment this FG can contain up to or including 27% weight of fluorine. In another preferred embodiment this FG can contain 27%, but less than 58%, weight of fluorine. In still another preferred embodiment this FG can contain 58%, or over, weight of fluorine.

The anode of the battery may be selected from the known list of metals capable of being oxidized, typical such as zinc, cadmium, lead, iron, aluminum, lithium, magnesium, calcium; and other metals such as copper, cobalt, nickel, chromium, gallium, titanium, indium, manganese, silver, cadmium, barium, tungsten, molybdenum, sodium, potassium, rubidium and cesium.

The anode may also be of other typical constituents capable of being oxidized, examples include, but are not limited to hydrogen, (including but not limited to metal hydrides), inorganic salts, and organic compounds including aromatic and non-aromatic compounds. The anode may also be of other typical constituents used for lithium-ion anodic storage, examples include, but are not limited to lithium-ion in carbon based materials and metal oxides.

The electrically neutral alkaline ionic conductor utilized in the battery according to the present invention, comprises a medium that can support current density during battery discharge in an alkaline medium. A typical representative ionic conductor is an aqueous solution preferably containing a high concentration of a hydroxide such as KOH. In other typical embodiments, the electrically neutral ionic conductor comprises a high concentration of NaOH.

An electric storage battery according to the invention may be rechargeable by application of a voltage in excess of the voltage as measured without resistive load, of the discharged or partially discharged cell.

According to another embodiment of the invention, means are provided to impede transfer of chemically reactive species, or prevent electric contract between the anode and cathode. Said means includes, but is not limited to a non-conductive separator configured with open channels, a membrane, a ceramic frit, grids or pores or agar solution; such means being so positioned as to separate said half cells from each other.

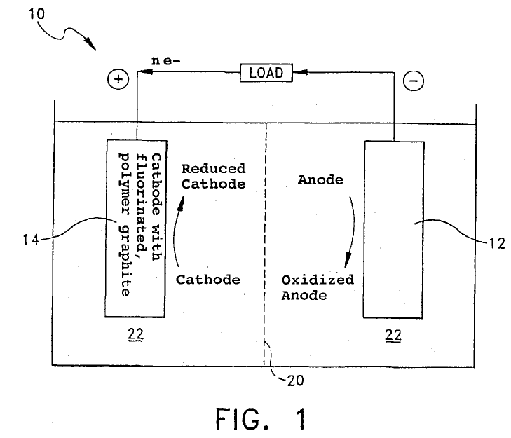

### DETAILED DESCRIPTION OF FIG. 1

FIG. 1 illustrates schematically an electrochemical cell 10 based on a cathode which contains a fluorinate, polymer graphite half cell, an electrically neutral alkaline ionic conductor and an anode. The cell contains an electrically neutral alkaline ionic conductor 22, such as a concentrated aqueous solution of KOH, in contact with a cathode which contains a fluorinate, polymer graphite 14. Reduction of the cathode, is achieved via electrons available from the electrode 14. The anode electrode 12, such as in the form of metal is also in contact with the electrically neutral ionic conductor 22. Electrons are released in the oxidation of the anode. Optionally, the cell may contain a separator 20, for minimizing the non-electrochemical interaction between the cathode and the anode.

The invention will be hereafter illustrated in further detail with reference to the following non-limiting examples, it being understood that the Examples are presented only for a better understanding of the invention without implying any limitation thereof, the invention being covered by the claims. Although the examples used AAA cells, it will be appreciated by those skilled in the art that the increase in performance may be obtained regardless of the cell size. It will be understood by those who practice the invention and by those skilled in the art, that various modifications and improvements may be made to the invention without departing from the spirit of the disclosed concept.

### Example 1

An experiment was carried out, the object being to examine the effect of addition of fluorinated, polymer graphites to Fe(VI) cathode materials, and leading to the first observation of greater than an expected 100% (Fe(VI)) cathode storage capacity. AAA alkaline batteries were constructed and discharged at 75Ω discharge load. The amount of measured discharge capacity was determined as a percentage of the theoretical capacity and plotted versus the measured discharge cell potential. In each case the cell used existing AAA Zn/MnO₂ commercial cells, from which all components (including the cathode case, separators, anode gel, anode current collector) were used except for the cathode material, which was replaced with the indicated cathode mix. To the cathodes were added 0.5 ml of 6 M KOH.

The cathodes contain a mix with either 1 micron graphite and carbon black, or a fluorinated, polymer graphite. The following cathode mixes were examined, where % refers to percent by weight:

TABLE 2
Fe(VI) cathode mixes studied, part 1 of 2.

| | | | % | | |
|---|---|---|---|---|---|
| Cell | Type Conductor | % Conductor | K₂FeO₄ | % BaFeO₄ | % KMnO₄ |
| A1 | 1 μm & carbon | (4 & 3 =)7 | 0 | 90 | 3 |
| | black | | | | |
| A2 | 1 μm & carbon | (6 & 4 =)10 | 0 | 85 | 5 |
| | black | | | | |
| A3 | 1 μm & carbon | (6 & 4 =)10 | 0 | 87 | 3 |
| | black | | | | |
| A4 | 1 μm & carbon | (9 & 6 =)15 | 0 | 82 | 3 |
| | black | | | | |
| B1 | 27% fluorinated | 10 | 0 | 90 | 0 |
| | graphite | | | | |
| B2 | 27% fluorinated | 15 | 0 | 80 | 5 |
| | graphite | | | | |
| C | 58% fluorinated | 10 | 0 | 85 | 0 |
| | graphite | | | | |

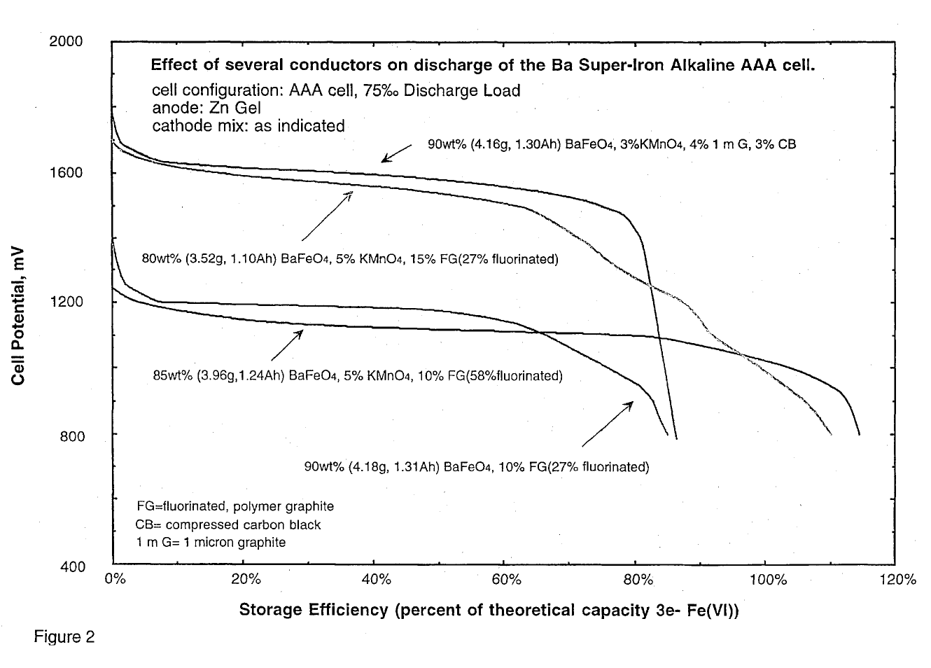

As seen in FIG. 2, a cell listed above as type A1 contained 4% 1 μm graphite, 3% carbon black, 90% BaFeO₄, and 3% KMnO₄ and discharges to nearly 90% of the Fe(VI) three electron theoretical capacity. Increases in KMnO4, as in A2, or in % conductor as in A3 or A4 did not significantly change the cell output (not shown). As seen in FIG. 2, a cell listed above as type B1, and 10% of the FG(29%) does not exhibit a storage capacity as greater than with the (A1 cell) 1 μm graphite and carbon black. However, cells using either 15% of FG(27%), as in B2, or using 10% of FG(58%) as in C, not only exhibit a higher storage capacity, but as seen in FIG. 2 this nominal storage capacity is over 100%. This effect was further explored with the additional set of cathode mixes:

TABLE 3
Fe(VI) cathode mixes studied, part 2 of 2.

| | | % | % | % | % |
|---|---|---|---|---|---|
| Cell | Type Conductor | Conductor | K₂FeO₄ | BaFeO₄ | KMnO₄ |
| B3 | 27% fluorinated graphite | 90 | 0 | 5 | 5 |
| D1 | 27% fluorinated graphite | 90 | 0 | 0 | 10 |
| E2 | 1 μm graphite | 90 | 0 | 0 | 10 |
| E1 | 27% fluorinated graphite | 90 | 5 | 0 | 5 |
| E2 | 27% fluorinated graphite | 90 | 10 | 0 | 0 |
| F | 1 μm graphite | 90 | 10 | 0 | 0 |

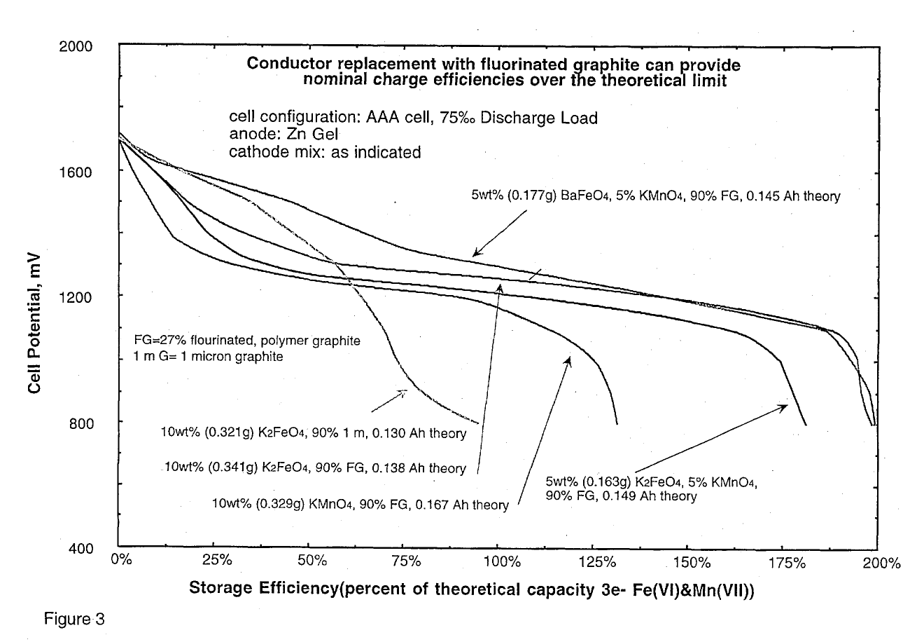

As see in FIG. 3, the discharge of 10% K₂FeO₄ in 90% 1 micron graphite, leads to the expected near 100% of the theoretical three electron storage capacity. However, replacement of the 10% 1 micron graphite with 10% of the fluorinated graphite leads to nearly 200% of the theoretical three electron storage capacity. The similar discharge of 10% KMnO₄ in 90% FG, provides over 130% storage capacity, compared to 70% storage capacity observed in the same cell but containing 90% of 1 micron graphite (not shown). A cell containing both 5% K₂FeO₄ and 5% KMnO_{4,} and 90% FG exhibits over 175% of the theoretical three electron storage capacity. Finally, the cell containing both 5% BaFeO₄ and 5% KMnO₄ as well as 90% FG exhibits nearly 200% of the theoretical three electron storage capacity.

### Example 2

An experiment was carried out, the object being to demonstrate that the increase beyond the conventional capacity with addition of FG could be observed for another cathode materials such as manganese dioxide. AAA alkaline batteries were constructed and discharged at 75Ω discharge load. The amount of measured discharge capacity was determined as a percentage of the theoretical capacity and plotted versus the measured discharge cell potential. In each case the cell used existing AAA Zn/MnO₂ commercial cells, from which all components (including the cathode case, separators, anode gel, anode current collector) were used except for the cathode material, which was replaced with the indicated cathode mix. The MnO₂ cathode material in the original cell was washed, centrifuged and dried, to remove electrolyte and any existing graphite. This MnO2 was then reused in the cathode mix with either the indicated 1 micron graphite or the fluorinated graphite. To the cathodes were added 0.5 ml of 6 M KOH.

TABLE 4
MnO₂ cathode mixes studied.

| Cell | Type Conductor | % Conductor | % MnO₂ |
|---|---|---|---|
| G1 | 1 μm graphite | 90 | 10 |
| G2 | 27% fluorinated graphite | 90 | 10 |

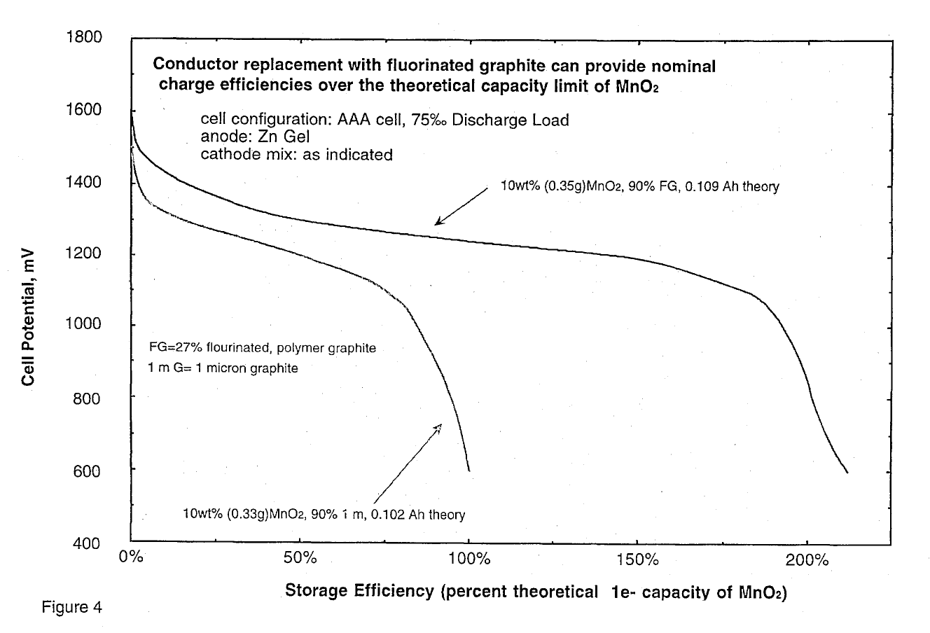

As see in FIG. 4, the discharge of 10% MnO₂ in 90% 1 micron graphite, leads to the expected near 100% of the theoretical one electron storage capacity of MnO₂ (308 Amp hour/g). However, replacement of the 10% 1 micron graphite with 10% of the fluorinated graphite leads to nearly 200% of the theoretical three electron storage capacity.

### Example 3

An experiment was carried out, the object being to demonstrate that the increase beyond the conventional capacity with addition of FG could be observed for another cathode materials such as nickel oxyhydroxide, or silver oxide. AAA alkaline batteries were constructed and discharged at 75Ω discharge load. The amount of measured discharge capacity was determined as a percentage of the theoretical NiOOH or Ag₂O one electron storage capacity. In each case the cell used existing AAA Zn/MnO₂ commercial cells, from which all components (including the cathode case, separators, anode gel, anode current collector) were used except for the cathode material, which was replaced with the indicated cathode mix.

In the first case, after removal from charged AA metal hydride cells, the nickel oxyhydroxide cathode material was washed, dried and used in the cathode mix. To the cathodes were added 0.5 ml of 6 M KOH. As seen in Table 4, replacement of the 1 micron graphite with either 27% or 58% fluorinated graphite lead to an increase of storage efficiency from 94% to respectively 196% and 193% storage efficiency. With the 85% 1 μm graphite (15% NiOOH) cell, the cell potential during 75Ω discharge displayed a single plateau at approximately 1650 mV and then falling. Instead with 85% of either fluorinated graphite (and 15% NiOOH), the cell potential during 75Ω discharge displayed two plateaus at approximately 1650 mV and 1250 mV and then falling.

In the second case, after removal from conventional silver oxide button cells, the silver oxide cathode material was washed, dried and used in the cathode mix. To the cathodes were added 0.5 ml of 6 M KOH. As seen in Table 5, replacement of the 1 micron graphite with 27% % fluorinated graphite lead to an increase of storage efficiency from 100% to 203% storage efficiency. With the 85% 1 μm graphite (15% silver oxide) cell, the cell potential during 75Ω discharge displayed a single plateau at approximately 1500 mV and then falling. Instead with 85% of either fluorinated graphite (and 15% silver oxide), the cell potential during 75Ω discharge displayed two plateaus at approximately 1500 mV and 1250 mV and then falling.

TABLE 4
NiOOH cathode mixes studied and their measure storage efficiency.

| | | | | Storage |
|---|---|---|---|---|
| | | | | Efficiency |
| | | % | % | from 292 Amp |
| Cell | Type Conductor | Conductor | NiOOH | hr/g NiOOH |
| H1 | 1 μm graphite | 85 | 15 | 94% |
| H2 | 27% fluorinated graphite | 85 | 15 | 196% |
| H3 | 58% fluorinated graphite | 85 | 15 | 193% |

TABLE 5
Ag₂O cathode mixes studied and their measure storage efficiency.

| | | | | Storage |
|---|---|---|---|---|
| | | | | Efficiency |
| | | % | % | from 231 Amp |
| Cell | Type Conductor | Conductor | Ag₂O | hr/g Ag₂O |
| H4 | 1 μm graphite | 85 | 15 | 100% |
| H5 | 27% fluorinated graphite | 85 | 15 | 203% |

### Example 4

An experiment was carried out, the object being to demonstrate that the increase of the discharge capacity, beyond the conventional capacity, with addition of FG observed using small portions of known cathode materials, could be also observed in cathodes containing large portions of the known cathode material. AAA alkaline batteries were constructed and discharged at an indicated constant resitsance load.

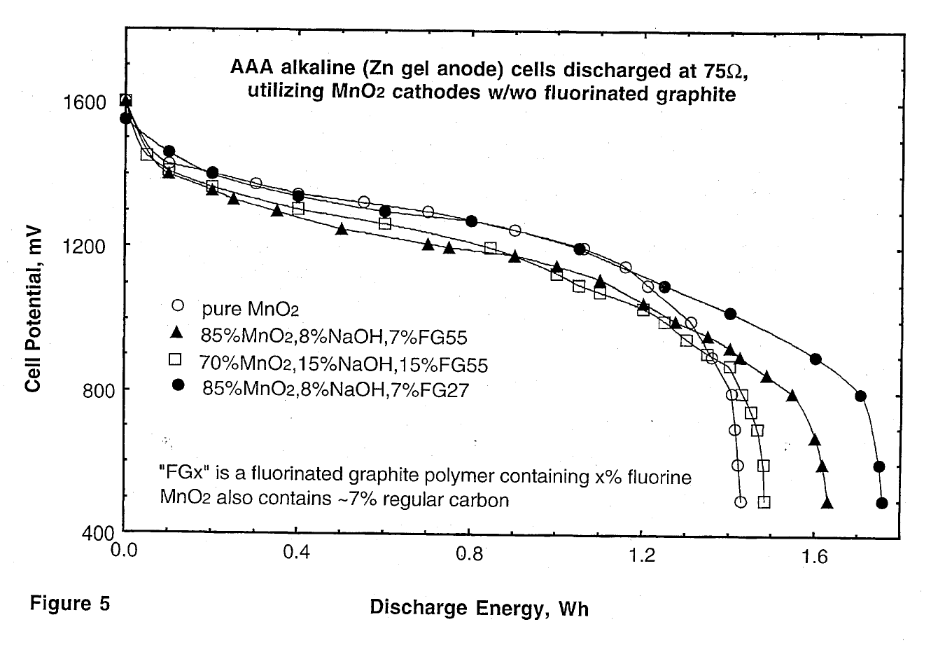

FIG. 5, presents alkaline cells in a cylindrical alkaline AAA cell configuration discharged at 75Ω. One discharge (indicated as circles) utilizes the conventional MnO₂/carbon mix, and at 75Ω generates the expected discharge energy. When 30% of this cathode mix is replaced with a fluorinated graphite polymer containing 55% fluorine, and indicated as FG55 and NaOH, the cell exhibits (as solid triangles in the figure) a substantial increase, (a relative 10% increase in Wh) is observed when 15% of this cathode mix is replaced with a fluorinated graphite polymer containing 55% fluorine, and indicated as FG55 and NaOH. Alternately, when 15% of the cathode mix is replaced with either 7% FG(55%) or 7% FG(27%), and also 8% NaOH, the cell is seen (as solid triangles) to generate a significant 10 to 20% increase in Wh discharge capacity.

The fluorinated graphite increase in capacity of a conventional alkaline cathode material is again demonstrated with the active material AgO. In the aforementioned AAA configuration cell, when the cathode is comprised of 40 wt% AgO and 60 wt% regular (non-fluorinated 1 μm graphite), the cell discharges to 0.97 and 0.48 Wh respectively under 75 or 2.8 Ω load. Alternatively when the cathode is prepared from 40 wt% AgO and 40 wt% FG43 (a fluorinated graphite polymer containing 43% fluorine) and 20 wt% NaOH the cell discharges to 1.48 and 1.07 Wh respectively under 75 or 2.8 Ω load.

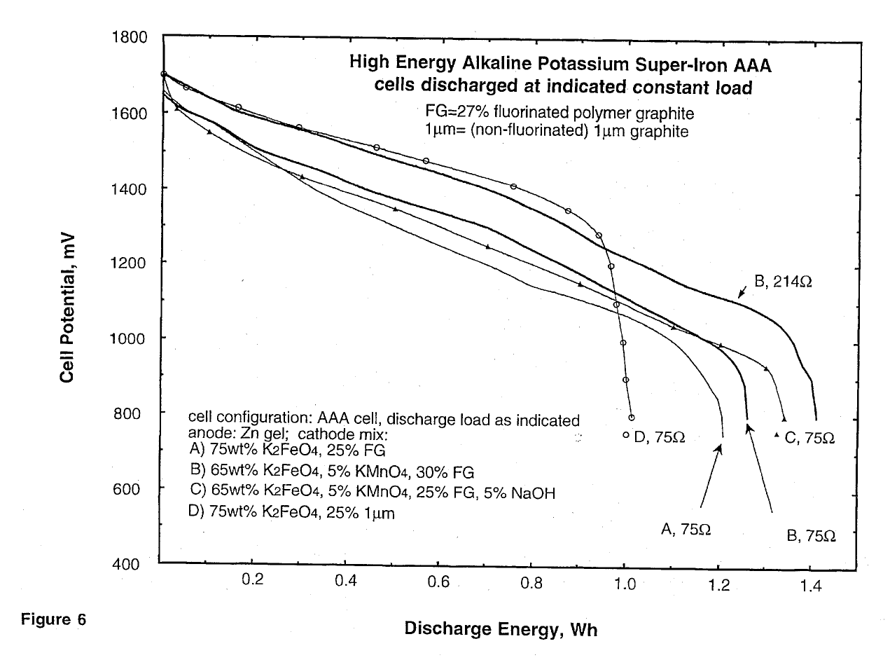

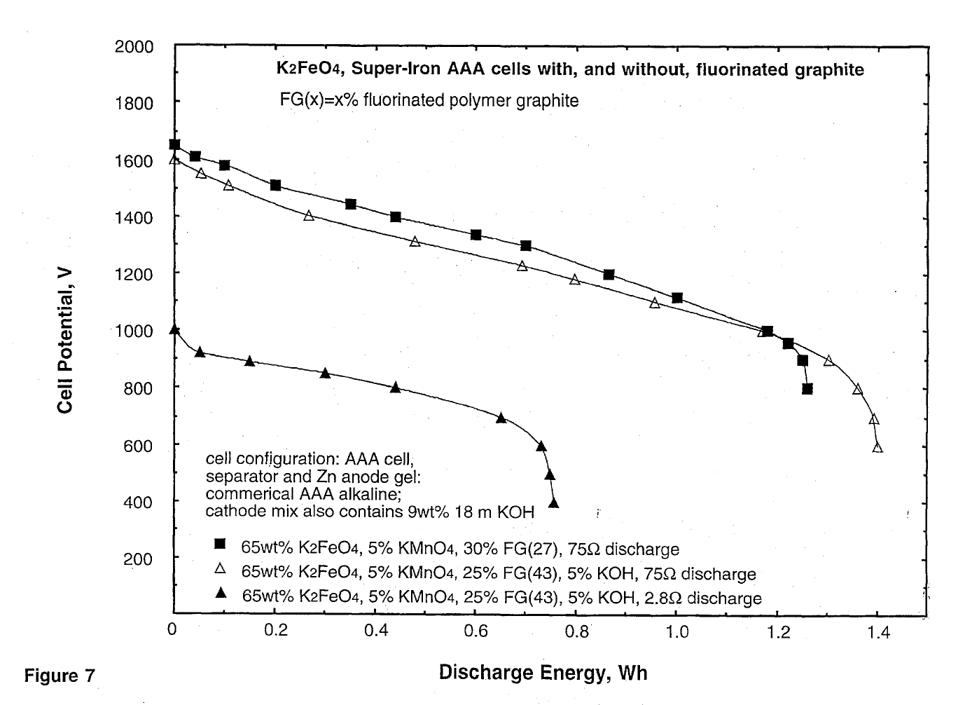

FIG. 6, presents alkaline cells in a cylindrical alkaline AAA cell configuration discharged at 75 or 214Ω. One discharge (indicated as circles) utilizes a K₂FeO₄ cathode mixed with 25% of a conventional (non-fluorinated) graphite, and at 75Ω generates the expected discharge energy. When this graphite is replaced with a fluorinated graphite polymer containing 27% fluorine, with or without added NaOH, the cell exhibits a substantial increase in discharge energy. FIG. 7 presents that the discharge capacity can be further enhanced through use of alternate fluorinated graphites, such as a fluorinated graphite polymer containing 43% fluorine, and that which such cathodes, the cells can be discharged to a significant capacity at high rate, such as in the presented 2.8Ω load discharge.

1. A battery comprising two half-cells which are in an electrochemical contact with one another through an electrically neutral alkaline ionic conductor, wherein one of said half-cells comprises an anode and the other half-cell comprises a cathode, whereby electrical discharge is accomplished via reduction of the cathode and oxidation of the anode, and whereby said cathode comprises a known cathode material, and where the cathode has a discharge capacity greater than the conventional storage capacity of the known cathode material due to the addition of at least 1% of weight of a fluorinated, polymer graphite.

2. A battery comprising two half-cells which are in an electrochemical contact with one another through an electrically neutral alkaline ionic conductor, wherein one of said half-cells comprises an anode and the other half-cell comprises a cathode, whereby electrical discharge is accomplished via reduction of the cathode and oxidation of the anode, and whereby said cathode comprises a known cathode material, and where the cathode has a discharge capacity greater than the conventional storage capacity of the known cathode material due to the addition of at least 10% of weight of a fluorinated, polymer graphite.

3. The battery according to claim 1 or 2, wherein said known cathode material is predominantly manganese dioxide.

4. The battery according to claim 1 or 2, wherein said known cathode material is predominantly a permanganate Mn(VII) salt.

5. The battery according to claim 1 or 2, wherein said known cathode material is predominantly a manganate Mn(VI) salt.

6 The battery according to claim 1 or 2, wherein said known cathode material is predominantly nickel oxyhydroxide.

7. The battery according to claim 1 or 2, wherein said known cathode material is predominantly silver oxide.

8. The battery according to claim 1 or 2, wherein said known cathode material is predominantly mercury oxide.

9. The battery according to claim 1 or 2, wherein said known cathode material is predominantly an Fe(VI) salt.

10. The battery according to claims 1 to 7, wherein said cell is rechargeable by application of a voltage in excess of the discharge cell open circuit potential.

11. The battery according to claims 1 to 8, wherein said known fluorinated, polymer graphite contains up to or including 27% weight of fluorine.

12. The battery according to claims 1 to 8, wherein said known fluorinated, polymer graphite contains over 27%, but less than 58%, weight of fluorine.

13. The battery according to claims 1 to 8, wherein said known fluorinated, polymer graphite contains 58% or over, weight of fluorine.
